(19) United States
(12) Patent Application Publication
(10) Pub. No.: US 2014/0255219 A1
(43) Pub. Date: Sep. 11, 2014

(54) Valve Configuration For Single Piston Fuel Pump

(71) Applicant: Stanadyne Corporation, Windsor, CT (US)

(72) Inventor: Robert G. Lucas, Ellington, CT (US)

(21) Appl. No.: 14/194,955

(22) Filed: Mar. 3, 2014

Related U.S. Application Data
(60) Provisional application No. 61/772,625, filed on Mar. 5, 2013.

(51) Int. Cl. F04B 49/22; F02M 21/02

(52) U.S. Cl. CPC F04B 49/225; F02M 21/0245
USPC 417/282

(57) ABSTRACT

A single piston fuel pump comprising a pump housing a pump inlet and an outlet. The pump housing mounts a proportional solenoid operated inlet metering valve with variable orifice, an inlet check valve, a pumping chamber, a pumping piston, an outlet check valve, and a pressure relief valve, wherein the inlet metering valve, the inlet check valve, the outlet check valve, and the pressure relief valve are all mounted on a common axis.

### CROSS-REFERENCES TO RELATED APPLICATION

This application claims the benefit of U.S. Provisional Patent Application No. 61/772,625 entitled “Electronically Controlled Inlet Metered Single Piston Fuel Pump”, filed Mar. 5, 2013, the disclosure of which is incorporated herein by reference in its entity.

### TECHNICAL FIELD

This application relates generally to single piston fuel supply pumps, and more particularly, to a valve configuration for such pumps.

### BACKGROUND

Gasoline Direct Injection (GDI) fuel systems typically entail costs to original equipment vehicle manufacturers compared to conventional multi-port injection (MPI) systems. In addition to the in-tank low pressure feed pump, GDI systems also require an engine mounted high pressure pump. The higher pressures required for the GDI systems have also proven to be audibly louder. In the past few years, there have been some gains in driving down the cost of the GDI fuel pump through simplification and size reduction. However, noise remains a key customer complaint.

Current state of the art GDI pumps as disclosed in Hitachi, U.S. Pat. No. 7,401,594 and Bosch, U.S. Pat. No. 7,707,996 employ a digital on/off-type solenoid control output via accurately timed closing of the inlet check valve with respect to the cam pumping ramp. In these types of pumps, the pumping chamber fully charges during every cycle, and then produces backflow into the low pressure circuit of the fuel that is un-pressurized. Those embodiments suffer from high audible noise associated with the opening and closing impacts of the high speed on/off-type solenoid operated valve. Additionally, the backflow causes excess pressure pulsations in the inlet line that are countered by the pump supplier adding inlet pressure dampeners.

### SUMMARY

The disclosed improvements simplify and reduce the cost of a GDI single piston pump, as well as reducing the noise level and inlet pressure pulsations produced by the pump. The pump output is varied via electronic control of a proportional solenoid operated inlet metering valve. The inlet metering valve assembly incorporates the pump inlet check valve. The inlet check valve is also in part controlled by the proportional solenoid when zero fuel delivery is commanded, thereby allowing a robust method of complete pump output shut-off when desired.

The proportional solenoid operated inlet metering valve is positioned at a fixed location for a given desired flow, thereby eliminating advance characteristics associated with pumps that use high speed, on/off-type solenoid operated valves. The lower pressure rise rate in the pumping chamber associated with inlet metering results in less audibly generated noise during partial load operation. Additionally, the inlet metering principle eliminates the need for a low pressure pump mounted pulsation damper due to the eliminated backflow that is associated with conventional GDI single piston pump operating principles characterized by the pumping chamber being fully charged during each pumping event.

According to one aspect of the disclosure, a single piston fuel pump is provided comprising a pump inlet and an outlet and mounting a proportional solenoid operated inlet metering valve, a pumping chamber, a pumping piston and sleeve, an outlet check valve, and a pressure relief valve, wherein the inlet metering valve and the inlet check valve are mounted on a common axis.

According to another aspect, a single piston fuel pump is provided comprising a pump housing having a pump inlet and an outlet and mounting a proportional solenoid operated inlet metering valve with variable orifice, an inlet check valve, a pumping chamber, a pumping piston, an outlet check valve, and a pressure relief valve, wherein the inlet metering valve, the inlet check valve, the outlet check valve, and the pressure relief valve are all mounted on a common axis.

### BRIEF DESCRIPTION OF THE DRAWINGS

FIG. 1 is an annotated schematic diagram of a fuel injection system incorporating an electrically controlled inlet metered single piston fuel pump;

FIG. 2 is an annotated central cross-sectional view of the pump of FIG. 1;

FIG. 3 is a second annotated cross-sectional view of the pump of FIG. 1;

FIG. 4 is a sectional view, partly diagrammatic, of the inlet metering valve and inlet check valve assembly for the pump of FIGS. 1; and

FIG. 5 is an enlarged cross-sectional view of the pump of FIG. 1 showing the orifice and its relationship to the piston valve.

### DETAILED DESCRIPTION

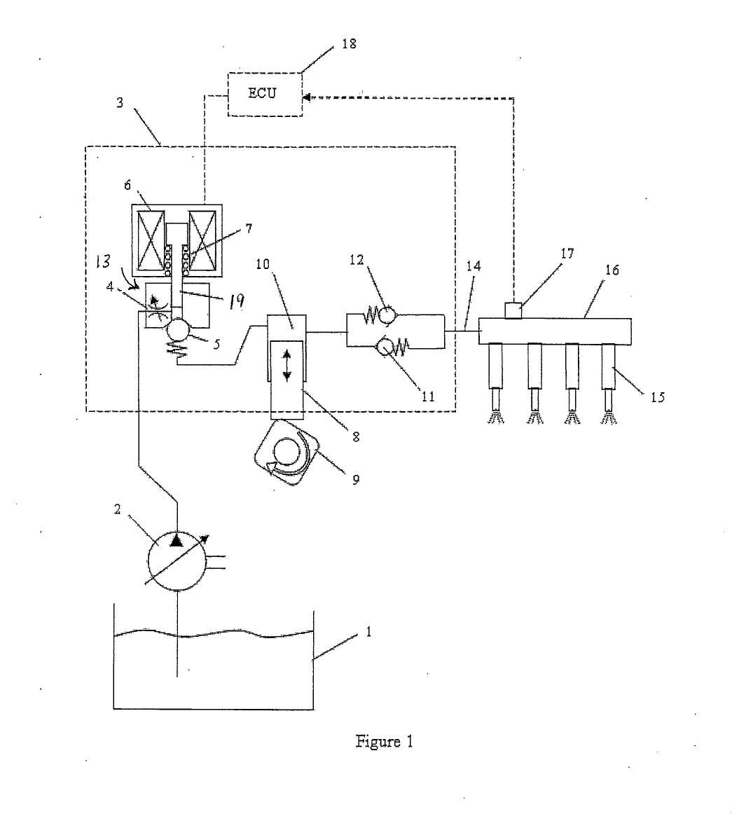

With reference to the drawings wherein like numerals represent like components, FIG. 1 shows an injection system schematic including an electronically controlled inlet method single piston fuel pump.

A pump 2 draws fuel from the fuel tank 1 and pumps it through the chassis fuel line and into the inlet passage of the high pressure GDI pump 3. The fuel then flows through the variable orifice 4 of the inlet metering (throttle) valve 12, then through the inlet check valve 5 and into the pumping chamber 10 during the charging stroke of the pumping plunger 8. The inlet check valve 5 is positioned between the metering valve 13 and the pumping chamber 10 and biased to permit fuel flow to the pumping chamber 10 during the intake phase and to prevent fuel pumped at high pressures from flowing into the inlet passage during the pumping phase.

During the pumping stroke, the pumping plunger 8 is driven by the engine cam 9 (usually through a lifter not shown), thereby compressing the fuel in the pumping chamber 10. The compressed fuel then flows through the outlet check valve 11, the high pressure line 14 and into the common fuel rail 16. A relief value 12 assures that the rail pressure does not exceed a safe maximum, but is not controlled for regulating rail pressure according to demand.

The fuel injectors 15 spray atomized fuel into the engine combustion chamber (not shown). The fuel injectors 15 are electronically controlled via the engine ECU 18. The ECU 18 uses the injector 15 control information as well as the pressure sensor 17 electrical signal to determine the appropriate current level to send to the proportional solenoid 6.

The proportional solenoid 6 generates a magnetic force that acts to move the inlet metering valve piston 19, compressing the inlet metering valve spring 7, and varying the size of the inlet metering valve variable orifice 4, thereby controlling the flow rate through the high pressure pump 3. In the disclosed embodiment, the orifice size is varied by position of the piston 19 end face with respect to a narrow feed slot on the side of the piston bore. Higher current levels cause additional advancement of the piston 13, until the orifice is closed, ideally delivering no fuel when commanded. However, a common problem with similar conventional inlet metering valves is leakage between the bore and the piston 19 at the orifice 4 due to wear of the piston and/or the bore, thereby causing uncommanded flow and excess rail pressure. Since the pumping plunger 8 continuously reciprocates while the engine is turning any uncommanded fuel delivered to the pumping chamber 10 will be pressurized and delivered to the rail 16 even if the rail pressure is at a maximum level or permitted pressure. According to this disclosure, such a deficiency is alleviated.

If rail pressure continues to rise when the inlet metering valve variable orifice 4 is fully closed, the ECU can send a higher current level to the proportional solenoid 6. Higher current advances the inlet metering valve piston 19 still further until it pushes open the inlet check valve 5. This exposes the pumping chamber 10 to the face of closed valve piston 19. By holding open the inlet check valve 5, any small amount of fuel that leaked by the inlet metering valve piston 13 will pass back and forth past the inlet check valve 5 during the cycles of the pumping plunger 8. The latter creates a hydraulic open circuit (by keeping the inlet check ball from sealing against its seat), and eliminating additional high pressure flow.

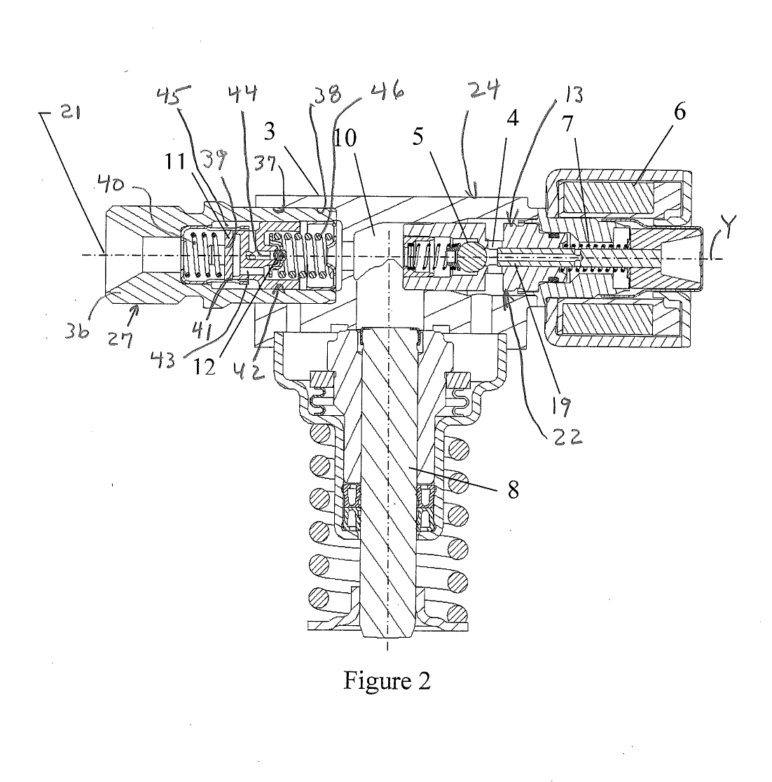

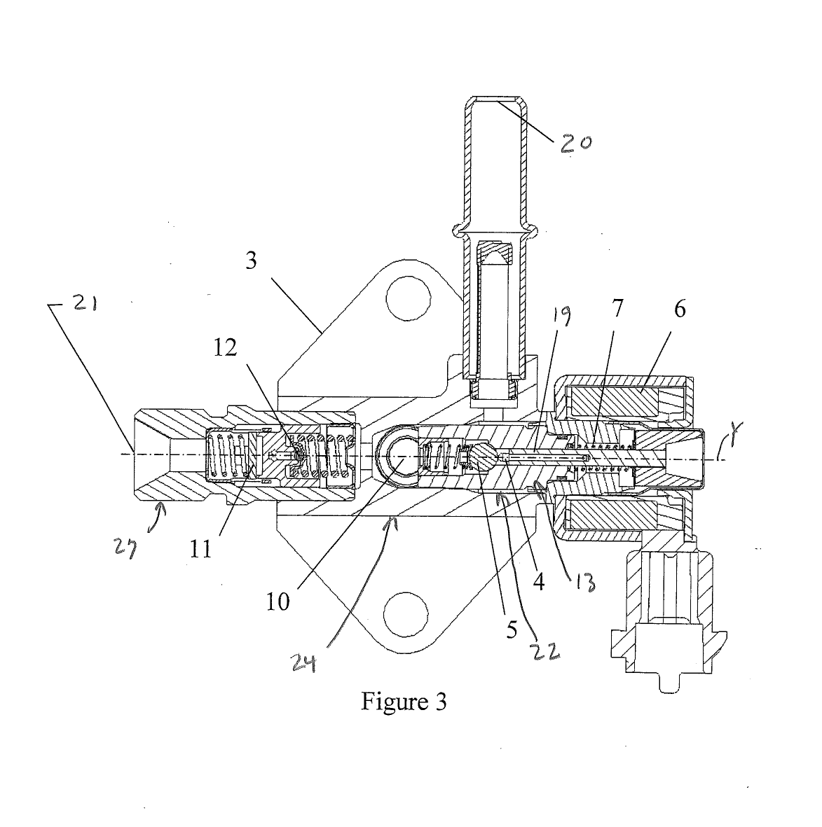

As shown in FIGS. 2 and 3, the components are arranged whereby the inlet metering (throttle) valve 13 with the variable orifice 4, the inlet check valve 5, the outlet check valve 11 and the common rail pressure relief valve 12 are mounted on a common axis “Y”. An inlet port 20, having an axis perpendicular to the Y axis delivers fuel from the pump 2 to the orifice 4 of the metering valve 13. A discharge port 21 delivers fuel to the high pressure line 14.

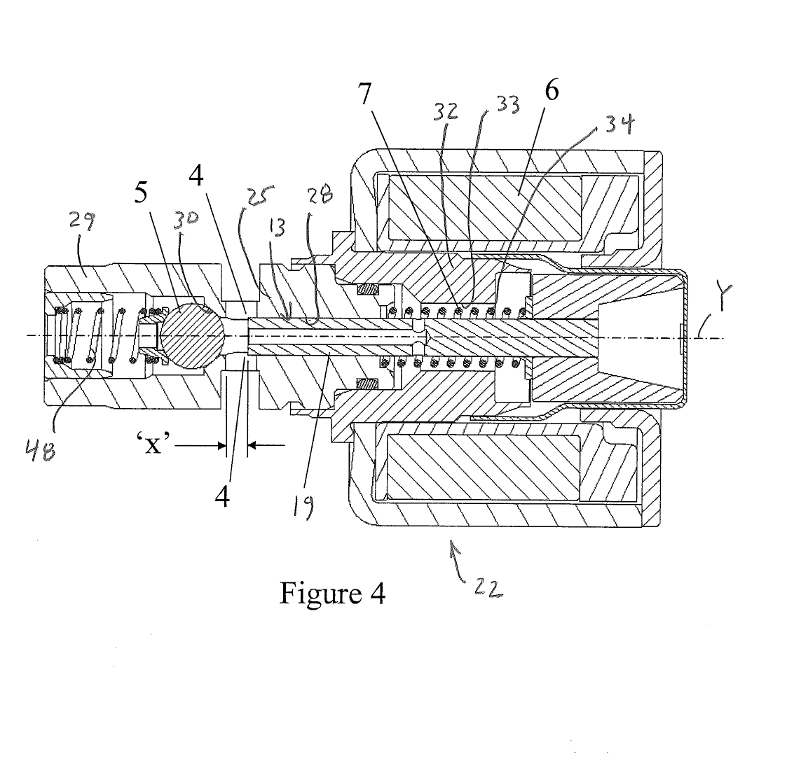

The inlet metering valve 13 and the inlet check valve 5 are mounted in a common sub-assembly 22 that has an axis coaxial with the “Y” axis. The sub-assembly 22, as shown particularly in FIG. 4, includes a valve body 25 having a bore 28 therein extending along the Y axis in which the metering valve piston 19 reciprocates. The forward end of the valve body includes a tubular head portion 29 having a valve seat 30 formed therein. The ball member 5 is positioned in the tubular head portion 29 and is spring biased by a spring 48 against its valve seat 30.

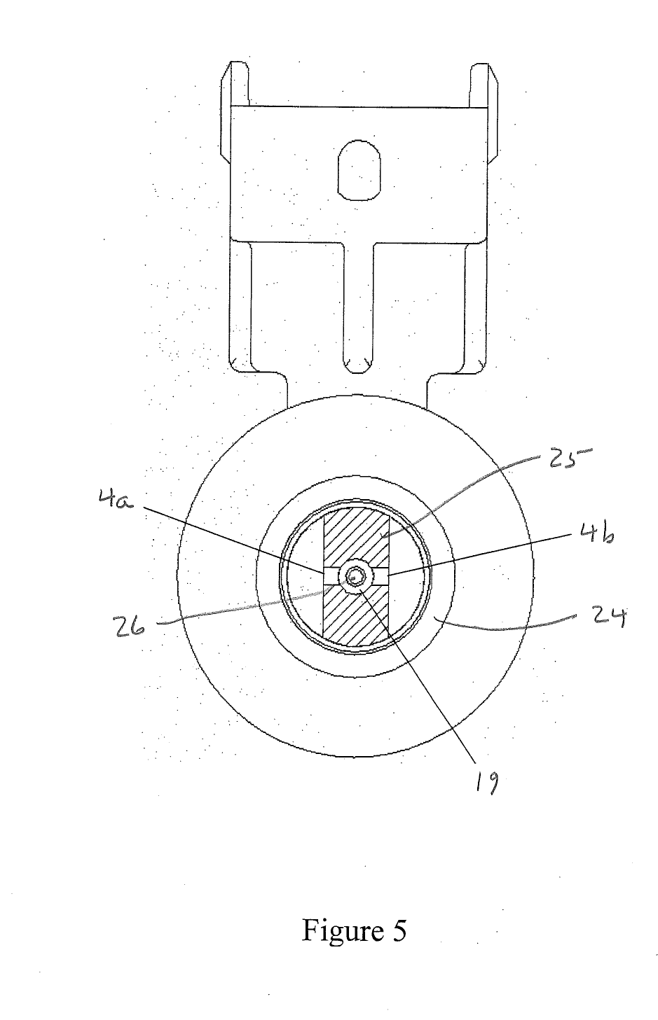

Fluid flows from the inlet port 21 to a plenum 23 in the pump housing 24. The orifice 4 can be in the form of two opposed axially aligned slots 4a, 4b in the valve body 25 fed by the plenum 23 as shown in FIG. 5. The piston 19 may have an internal bore 26 for providing cooling flow to the internal of solenoid 6.

A member 32 is attached to the outer end of the valve body 25 and includes a bore 33 in which the piston 19 is located. A spring 34 extends between the outer face of the valve body 25 and a head 35 on the outer end of the piston 19 to bias the piston 19 outward into its open most position relative to the orifice 4. The solenoid 6 is mounted on the member 32. The valve body 25 is mounted in a bore in the pump housing 24.

The outlet check valve 11 and the pressure relief valve 12 may also be formed as a sub-assembly 27 as shown in FIGS. 2 and 3. This sub-assembly 27 has an axis coaxial with the Y axis. The sub-assembly 27 includes a sleeve 36 having a bore 37 in which the spring biased outlet check valve 11 and the spring biased relief valve 12 are mounted. The sleeve 36 has its inner end mounted in a bore 38 in the pump housing 24. The outlet 21 is provided at the outer end of the sleeve 36.

The outlet check valve 11 includes a valve plate 39 biased by a spring 40 against the sealing face 41 of a valve seat member 42 mounted in the sleeve 36. The valve seat member 42 has a passageway 43 therein thorough which the high pressure fuel flows from the pumping chamber 10. The flow of the high pressure fuel unseats the valve plate 39 from its sealing face 41 against the bias of the spring 40 so that the high pressure fuel may flow to the outlet 21.

A second passageway 44 in the valve seat member 42 communicates at its outer end with a plenum 45 in the sleeve 36. The plenum 45 is in communication with the interior of the sleeve 36 downstream of the valve plate 39. The inner end of passageway 44 communicates with the interior of the sleeve 36 upstream of the valve seat member 42 and is provided with a valve seat against which the valve member of the relief valve 12 is biased by a spring 46 as shown in FIG. 2.

With this arrangement the outlet check valve 11 and relief valve 12 are in axial alignment along the Y axis. The outlet check valve 11 is positioned axially outward of the relief valve 12 as shown.

The two subassemblies 22 and 27 are mounted in the valve pump housing 24 spaced from each other on opposite sides of the pumping chamber 10. With this arrangement, the two sub-assemblies are coaxial along the Y axis.

FIG. 4 shows a cross-section of the inlet metering (throttle) valve and integrated inlet check valve assembly. During normal operation, the ECU 18 provides the proportional solenoid 6 with an appropriate current level to position the inlet metering valve piston 13 within an operating range ‘x’ in order to adjust the inlet metering valve variable orifice 4 for the desired flow rate through the pump. A normally open inlet metering valve is shown in the figure, and the variable orifice 4 is wide open with no current applied to the proportional solenoid 6.

Within normal operating range ‘x’, the inlet metering valve piston 13 does not contact the inlet check valve 5. With a tight clearance between the inlet metering valve piston 13 and its bore 28, the flow thru the variable orifice 4 will be zero when ‘x’ =zero. However, if the piston 13 or its bore wears, there could be unwanted flow thru the orifice when ‘x’=zero. In this case, the ECU 18 can provide a higher current level to the proportional solenoid 6, further advancing the metering valve piston 13 until it contacts and pushes the inlet check valve 5 to an open position. Any flow past the orifice 4 during the pump charging stroke will flow past the inlet check valve 5, and will then flow backwards past it again during the pumping stroke because the inlet check ball will be held off its sealing seat 29, thereby delivering no high pressure pump flow.

With the above described arrangement, a valve configuration for a single piston fuel pump is provided that is relatively simple in design and is relatively easy to manufacture and assemble.

1. A single piston fuel pump comprising a pump inlet and an outlet and mounting a proportional solenoid operated inlet metering valve with variable orifice, an inlet check valve, a pumping chamber, a pumping piston and sleeve, an outlet check valve, and a pressure relief valve, wherein the inlet metering valve and the inlet check valve are mounted on a common axis.

2. The pump of claim 1 when the outlet check valve and pressure relief valve are mounted on a common axis.

3. A single piston fuel pump comprising a pump housing having a pump inlet and an outlet and mounting a proportional solenoid operated inlet metering valve with variable orifice, an inlet check valve, a pumping chamber, a pumping piston, an outlet check valve, and a pressure relief valve, wherein the inlet metering valve, the inlet check valve, the outlet check valve, and the pressure relief valve are all mounted on a common axis.

4. The pump of claim 3, wherein the pumping chamber is between the inlet check valve and the outlet check valve, and the pumping plunger reciprocates within the plunger sleeve on a pumping axis aligned perpendicularly to the flow axis.

5. The pump of claim 4, wherein the inlet includes an inlet plenum and the orifice is an axially aligned slot that is selectively increased and decreased to present variable flow cross-section as the inlet metering valve piston is farther and closer to the check valve, respectively.

6. The pump of claim 5, wherein the check valve is disposed between said slot and said pumping chamber.

7. The pump of claim 4 wherein said metering valve and said check valve are contained in a sub-assembly mounted in the pump housing.

8. The pump of claim 4 wherein said outlet check and said pressure relief valve are contained in a sub-assembly mounted in said pump housing.

9. The pump of claim 5 wherein said metering valve and said check valve are in a contained in a first sub-assembly and said outlet check valve and said relief valve are mounted in a second sub-assembly, said sub-assemblies being mounted in said pump housing on opposite sides of said pumping chamber.

10. The pump of claim 9 wherein the first and second sub-assemblies are coaxial.

11. The pump of claim 9 wherein said sub-assembly for said metering valve and said check valve includes a valve body having a bore therein, a piston operated by a solenoid mounted in said bore, a plenum in said pump housing, an orifice in said sleeve communicating with said bore, the piston arranged to reciprocate to provide variable opening of the orifice into bore.

12. The pump of claim 11 wherein said check valve includes a valve seat in said valve body, a ball spring biased against said seat, said valve seat being positioned between said orifice and said pumping chamber.

13. The pump of claim 12 wherein said sleeve of sub-assembly for said metering valve and said check valve is mounted in a bore in a pump housing.

14. The pump of claim 9 wherein said sub-assembly for said outlet check valve and said relief valve includes a sleeve having a bore therein, a valve seat member having a sealing face thereon mounted in said sleeve, a valve plate spring biased against said sealing face, and a passageway through said valve body providing communication between said pumping chamber and the bore downstream of valve member.

15. The pump of claim 14 wherein said sub-assembly for said outlet check valve and said relief valve further includes a second passageway through said valve seat member, a plenum in said sleeve communicating with the bore downstream of said valve plate, said second passageway providing communication between said plenum and the interior of the sleeve upstream of the valve seat member, a valve seat on the face on the inner against which a valve member of the relief valve is biased.

16. The pump of claim 15 wherein said sleeve of the sub-assembly assembly for said outlet check valve and said relief valve is mounted in a bore in a pump housing.
